(19) United States
(12) Patent Application Publication
(10) Pub. No.: US 2024/0187132 A1
(43) Pub. Date: Jun. 6, 2024

(54) RECEIVING DEVICE AND COMMUNICATION SYSTEM

(71) Applicant: SONY SEMICONDUCTOR SOLUTIONS CORPORATION, KANAGAWA (JP)

(72) Inventor: HIROYUKI OKUMURA, KANAGAWA (JP)

(21) Appl. No.: 18/548,449

(22) PCT Filed: Dec. 28, 2021
(86) PCT No.: PCT/JP2021/048926

§ 371 Date: Aug. 30, 2023

(30) Foreign Application Priority Data
Mar. 8, 2021 (JP) 2021-035975

(51) Int. Cl. H04L 1/00; H04L 1/1829

(52) U.S. Cl. CPC H04L 1/0045; H04L 1/1864

(57) ABSTRACT

A communication system increases the communication performance of wireless communication while suppressing the amount of computation of a receiving device. The communication system includes a receiving device and a transmitting device. The receiving device includes a memory, a hint information extraction circuit, and a reception processing circuit. The memory holds past signal data. The hint information extraction circuit extracts hint information from newly received signal data. The reception processing circuit reads the past signal data held in the memory based on the hint information and performs predetermined reception processing.

### TECHNICAL FIELd

The present technology relates to a receiving device. More specifically, it relates to a communication system for wireless communication and a receiving device thereof.

### BACKGROUND ART

Error correction coding, signal processing, and the like are used to improve communication performance in wireless communication. In two-way communication, a method of improving the success rate of reception by automatic repeat request (ARQ) is known. On the other hand, in one-way communication, for example, a method of transmitting the same information multiple times to improve communication performance has been proposed (see PTL 1, for example).

### CITATION LIST

### Patent Literature

[PTL 1]

JP 1107-123076A

### SUMMARY

### Technical Problem

The above-described conventional technologies have a problem that the amount of computation in a receiving device increases due to error correction, signal processing, and the like. In the case where the same information is transmitted multiple times in one-way communication, it is necessary to allocate a communication band to each communication channel, including another channel, which results in extra communication bands.

The present technology has been devised in view of such circumstances and an object thereof is to improve the communication performance of wireless communication while suppressing the amount of computation on a receiving device.

### Solution to Problem

The present technology has been made to solve the above-described problems, and a first aspect thereof is a receiving device including; a memory that holds past signal data; a hint information extraction circuit that extracts hint information from newly received signal data; and a reception processing circuit that reads the past signal data held in the memory based on the hint information to perform predetermined reception processing. This results in an operation of performing reception processing on the past signal data based on the hint information.

In the first aspect, the reception processing circuit may perform error correction processing as the predetermined reception processing, the memory may hold data in the middle of the error correction processing as the past signal data, the hint information extraction circuit may extract, as the hint information, information indicating whether transmission has been performed at a timing of the past signal data, and if the transmission has been performed at the timing of the past signal data, the hint information extraction circuit may cause the reception processing circuit to continue the error correction processing. This results in an operation of performing error correction processing on the past signal data based on the hint information.

In the first aspect, the hint information extraction circuit may extract information on backoff of the past signal data as the hint information, and cause the reception processing circuit to perform the predetermined reception processing on signal data at a timing according to the information on the backoff. This results in an operation of performing, based on the hint information, reception processing on the past signal data according to the information on the backoff.

In the first aspect, the hint information extraction circuit may extract information on an amount of deviation in time domain of the past signal data as the hint information, and cause the reception processing circuit to perform the predetermined reception processing on signal data at a timing according to the information on the amount of deviation in time domain. This results in an operation of performing reception processing according to the information on the amount of deviation in time domain.

In the first aspect, the hint information extraction circuit may extract information on a sequence number of the past signal data as the hint information, and cause the reception processing circuit to perform the predetermined reception processing on signal data of a timing according to the information on the sequence number. This results in an operation of performing reception processing according to the information on the sequence number.

In the first aspect, the hint information extraction circuit may extract, as the hint information, information on a moving speed of a transmitting device that has transmitted the past signal data, and cause the reception processing circuit to perform the predetermined reception processing according to the information on the moving speed. This results in an operation of performing reception processing according to the information on the moving speed.

In the first aspect, the hint information extraction circuit may extract, as the hint information, information on part of a payload of the past signal data, and cause the reception processing circuit to perform the predetermined reception processing using the information on the part of the payload as known data. This results in an operation of performing reception processing using the information on the part of the payload as known data.

In the first aspect, the hint information extraction circuit may further extract information indicating whether the hint information is enabled or not, and if the information indicating whether the hint information is enabled or not indicates that the hint information is enabled, extract the hint information. This results in an operation of determining whether the hint information is to be referred to.

A second aspect of the present technology is a communication system including; a transmitting device; a plurality of receiving devices each including a memory that holds past signal data having been transmitted from the transmitting device, a hint information extraction circuit that extracts hint information from newly received signal data, and a reception processing circuit that reads the past signal data held in the memory based on the hint information to perform predetermined reception processing; and a server that acquires the hint information from any one of the plurality of receiving devices and supplies the hint information to another one of the plurality of the receiving devices. This results in an operation of performing reception processing with the hint information shared by the plurality of receiving devices.

A third aspect of the present technology is a communication system including: a transmitting device; a plurality of receiving devices each including a hint information extraction circuit that extracts hint information from newly received signal data; and a server including a memory that holds past signal data having been received from the receiving device, and a reception processing circuit that acquires the hint information from any one of the plurality of receiving devices and reads the past signal data held in the memory based on the hint information to perform predetermined reception processing. This results in an operation of performing, in the server, reception processing with the hint information shared by the plurality of receiving devices.

### BRIEF DESCRIPTION OF DRAWINGS

FIG. 1 is a diagram illustrating an example of an overall configuration of a communication system according to a first embodiment of the present technology.

FIG. 2 is a diagram illustrating a configuration example of a receiving device 100 according to the first embodiment of the present technology.

FIG. 3 is a diagram illustrating a format structure example of signal data according to the first embodiment of the present technology.

FIG. 4 is a diagram illustrating an application example of hint information 712 according to the first embodiment of the present technology.

FIG. 5 is a flowchart illustrating an example of processing procedure of the receiving device 100 according to the first embodiment of the present technology.

FIG. 6 is a diagram illustrating a configuration example of the receiving device 100 in a modification example of the first embodiment of the present technology.

FIG. 7 is a flowchart illustrating an example of processing procedure of a receiving device 100 according to a second embodiment of the present technology.

FIG. 8 is a flowchart illustrating an example of processing procedure of a receiving device 100 according to a third embodiment of the present technology.

FIG. 9 is a flowchart illustrating an example of processing procedure of a receiving device 100 according to a fourth embodiment of the present technology.

FIG. 10 is a diagram illustrating a format structure example of signal data according to a fifth embodiment of the present technology.

FIG. 11 is a flowchart illustrating an example of processing procedure of a receiving device 100 according to a sixth embodiment of the present technology.

FIG. 12 is a flowchart illustrating an example of processing procedure of a receiving device 100 according to a seventh embodiment of the present technology.

FIG. 13 is a diagram illustrating an example of an overall configuration of a communication system according to an eighth embodiment of the present technology.

FIG. 14 is a sequence diagram illustrating an example of a flow of processing according to a first example of the eighth embodiment of the present technology.

FIG. 15 is a sequence diagram illustrating an example of a flow of processing according to a second example of the eighth embodiment of the present technology.

### DESCRIPTION OF EMBODIMENTS

Modes for carrying out the present technology (hereinafter also referred to as embodiments) will be described below. The description will be given in the following order.
1. First Embodiment (an example of notifying the presence or absence of transmission as hint information)
2. Second Embodiment (an example of notifying the presence or absence of backoff as hint information)
3. Third Embodiment (an example of notifying an amount of deviation in time domain of transmission timing as hint information)
4. Fourth Embodiment (an example of notifying a sequence number as hint information)
5. Fifth Embodiment (an example of notifying hint information enable flag as hint information)
6. Sixth Embodiment (an example of notifying a moving speed of a transmitting device as hint information)
7. Seventh Embodiment (an example of notifying part of payload transmitted in the past as hint information)
8. Eighth Embodiment (an example in which a plurality of receiving devices share hint information via a cloud)

### 1. First Embodiment

### Configuration of Communication System

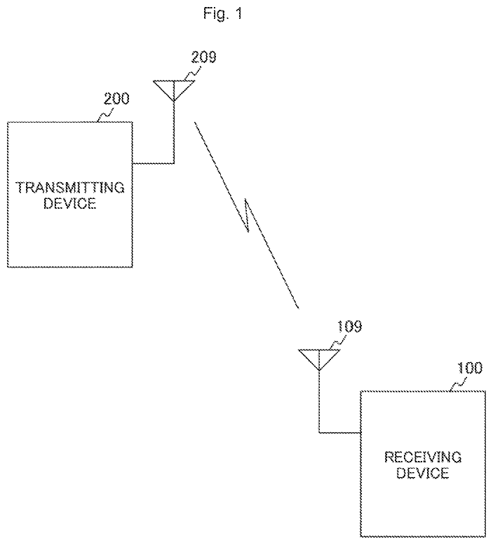

FIG. 1 is a diagram illustrating an example of an overall configuration of a communication system according to a first embodiment of the present technology. This communication system includes a receiving device 100 and a transmitting device 200. The transmitting device 200 is a communication device that transmits signals, and the receiving device 100 is a communication device that receives signals. The transmitting device 200 transmits signals via an antenna 209, and the receiving device 100 receives signals via an antenna 109.

In this example, one receiving device 100 and one transmitting device 200 are illustrated, but a plurality of receiving devices 100 and a plurality of transmitting devices 200 may be installed.

### Configuration of Receiving Device

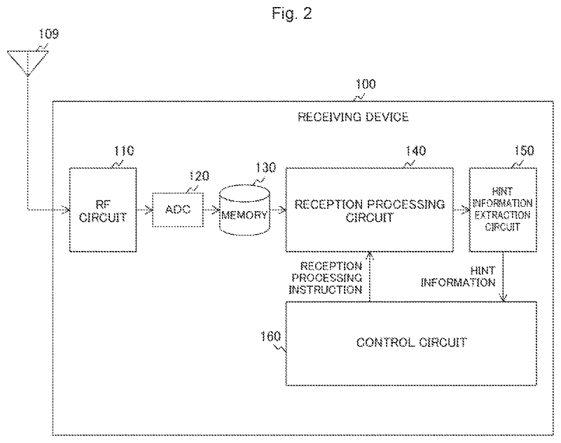

FIG. 2 is a diagram illustrating a configuration example of the receiving device 100 according to the first embodiment of the present technology.

This receiving device 100 includes an RF circuit 110, an ADC 120, a memory 130, a reception processing circuit 140, a hint information extraction circuit 150, and a control circuit 160.

The RF (Radio Frequency) circuit 110 is a high frequency circuit that converts a carrier signal received via the antenna 109 into an intermediate frequency signal. The RF circuit 110 includes a low noise amplifier (LNA), a phase locked loop (PLL) circuit, a mixer, a low pass filter (LPF), and the like.

The ADC (Analog-to-Digital Converter) 120 converts an output of the RF circuit 110 from an analog signal into a digital signal.

The memory 130 is a memory that holds signal data converted into a digital signal. This memory 130 is read based on hint information extracted from the signal data received later, as will be described later.

The reception processing circuit 140 performs predetermined reception processing on signal data. This reception processing circuit 140 performs, for example, demodulation processing and error correction as the reception processing.

The hint information extraction circuit 150 extracts hint information from the signal data on which the reception processing circuit 140 has performed the reception processing.

The control circuit 160 instructs the reception processing circuit 140 to perform the reception processing based on the hint information extracted by the hint information extraction circuit 150.

### Signal Data Format

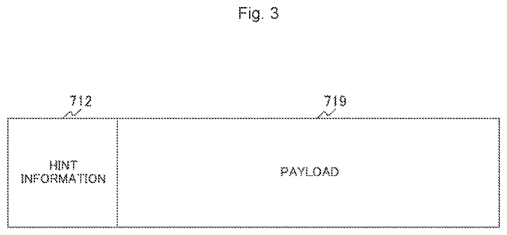

FIG. 3 is a diagram illustrating a format structure example of signal data according to the first embodiment of the present technology.

In this example, hint information 712 is attached to payload 719 in the signal data. This hint information 712 is information for receiving data transmitted in the past. The reception processing circuit 140 reads the past signal data held in the memory 130 based on the hint information 712 attached to the successfully received signal data, and performs the reception processing.

In this first embodiment, it is assumed that a communication method is used in which a data transmission start time (transmission timing) is allocated to the transmitting device 200 in advance, and error correction coding is adopted that improves the error correction performance with an increased number of iterations of processing. A specific example of such a method is low density parity check (LDPC).

### Hint Information

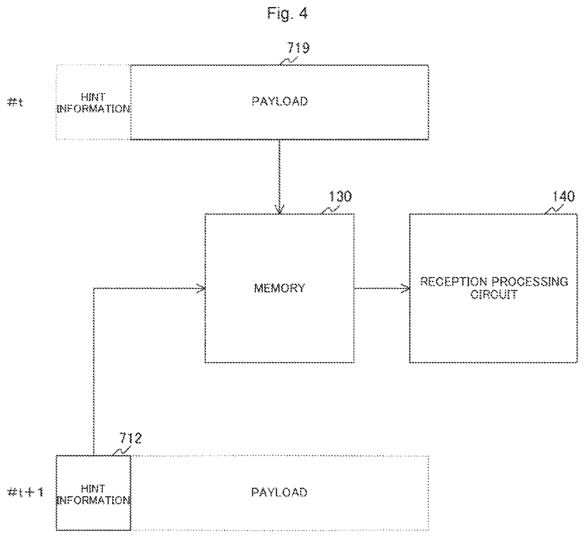

FIG. 4 is a diagram illustrating an application example of the hint information 712 according to the first embodiment of the present technology.

In this first embodiment, as the hint information 712, a flag indicating “whether or not the data was transmitted at the previous transmission timing” is attached. When the error correction is failed, the receiving device 100 causes the memory 130 to hold data on which the iterative processing of error correction has been performed.

When the receiving device 100 is failed to receive data at a certain timing t but successfully receive data at the next timing t+1, the receiving device 100 reads the data of the timing t from the memory 130 if the hint information 712 acquired at the timing t+1 indicates that “the transmitting device 200 transmitted the data at the timing t”. Then, the reception processing circuit 140 additionally performs the iterative processing of error correction for the reception processing at the timing t. This makes it possible to improve the communication performance while suppressing the occupied communication band and the amount of computation.

### Operation

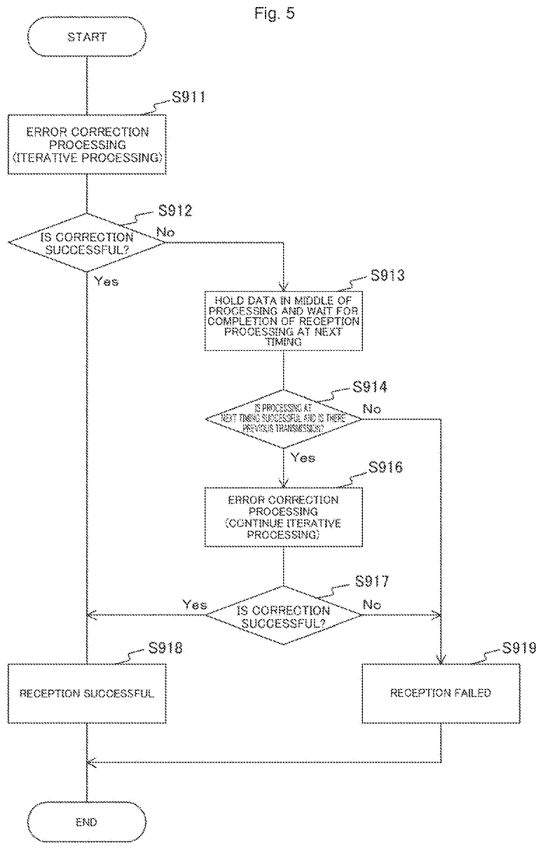

FIG. 5 is a flowchart illustrating an example of processing procedure of the receiving device 100 according to the first embodiment of the present technology.

At the timing t, the reception processing circuit 140 performs the reception processing and performs the iterative processing of error correction (step S911). As a result, when the error correction is successful (step S912: Yes), the reception processing at the timing t is also successful (step S918).

On the other hand, when the error correction is failed (step S912: No), the data in the middle of the processing is held in the memory 130, and the completion of the reception processing at the next timing t+1 is awaited (step S913).

When the reception processing at the next timing t+1 is successful and if the hint information 712 indicates that “the transmitting device 200 transmitted the data at the timing t” (step S914: Yes), the reception processing circuit 140 continues the iterative processing of error correction (step S916). As a result, when the error correction is successful (step S917: Yes), the reception processing at the timing t is also successful (step S918).

On the other hand, if the hint information 712 does not indicate that “the transmitting device 200 transmitted the data at the timing t”, or when the reception processing at the timing t+1 is failed (step S914: No), or when the error correction is failed (step S917: No), the reception processing at the timing t is failed accordingly (step S919).

As described above, in the first embodiment of the present technology, when it is notified with the hint information 712 that the data has been transmitted at the previous transmission timing, the iterative processing of error correction for the data at the previous transmission timing is continued. This makes it possible to improve the communication performance while suppressing the occupied communication band and the amount of computation in the receiving device 100.

### Modification Example

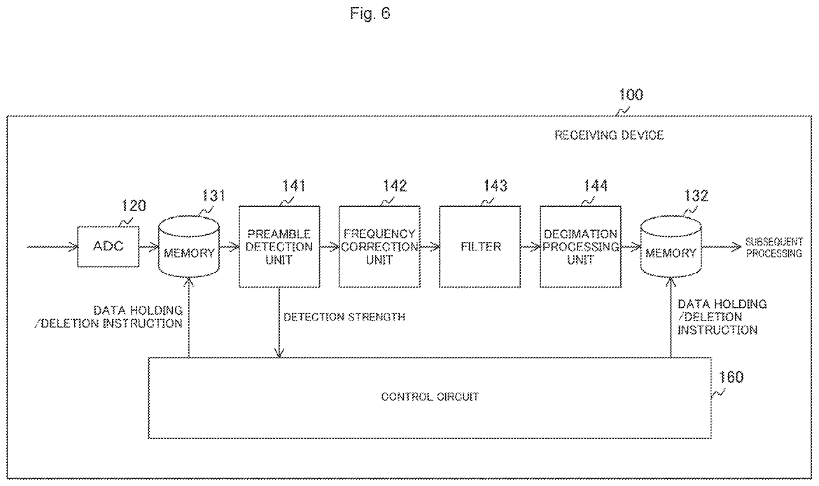

FIG. 6 is a diagram illustrating a configuration example of the receiving device 100 in a modification example of the first embodiment of the present technology.

In the above-described embodiment, the output data of the ADC 120 and the data in the middle of the iterative processing of error correction are held in the memory 130. However, other data may be held. For example, in the reception processing circuit 140, output data of a filter 143, output data of a decimation processing unit 144, data on which frequency correction, other time correction, phase correction, or the like is performed by a frequency correction unit 142, data in which noise is removed, and the like may be held in a memory 131 or 132.

Signal data to be held in the memory may be selected according to the percentage of the reception processing so that signal data of a smaller size can be held. For example, it is conceivable that data may be held according to the detection strength of a preamble detected by a preamble detection unit 141 so that if the detection strength is high, the data after preamble detection is held, and if the detection strength is low, the data before preamble detection is held. This makes it possible to reduce the amount of memory used while preventing the communication performance from being reduced.

### 2. Second Embodiment

In this second embodiment, assumed is a communication system in which the transmitting device 200 performs carrier sensing before transmitting data, and when detecting that another device is communicating, the transmitting device 200 shifts the transmission timing (backoff). In such a communication system, in a case where it can be assumed that the backoff is less likely to occur, especially that no backoff normally occurs, when the receiving device 100 speculatively performs the reception processing in assumption of the backoff, the amount of computation will increase excessively.

Therefore, in the second embodiment, the receiving device 100 holds the received signal data in the memory 130 for a certain period of time. The transmitting device 200 transmits transmission data including as the hint information 712 a flag indicating whether the backoff has occurred or a value indicating the time of backoff for the data transmitted in the past. When receiving the notification, from the transmitting device 200, that the backoff has occurred in the past transmission data, the receiving device 100 retrieves, from the signal data held in memory 130, signal data at a timing involving the backoff, and performs the reception processing. This makes it possible to improve the communication performance without excessively increasing the amount of computation in the receiving device 100.

Since the configuration of the receiving device 100 under such an assumption is the same as that of the first embodiment described above, detailed description thereof will be omitted.

### Operation

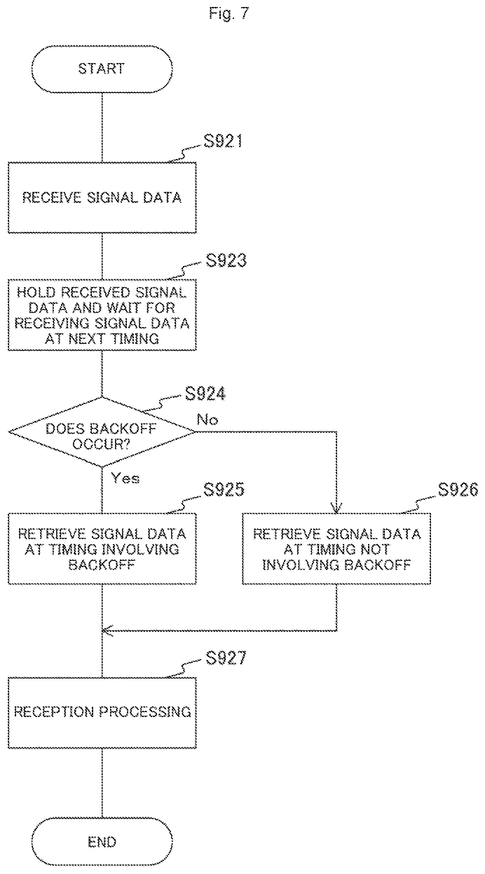

FIG. 7 is a flowchart illustrating an example of processing procedure of the receiving device 100 according to the second embodiment of the present technology.

The receiving device 100 receives signal data (step S921), holds it in the memory 130 for a certain period of time, and waits for reception of signal data at the next timing (step S923).

In response to a notification with the hint information 712 of the signal data from the transmitting device 200 at the subsequent the timing that the backoff has occurred in the past transmission data (step S924: Yes), the reception processing circuit 140 retrieves the signal data at the timing involving the backoff from the memory 130 in response to an instruction from the control circuit 160 (step S925), and performs the reception processing (step S927). On the other hand, when it is not notified that the backoff has occurred (step S924: No), the reception processing circuit 140 retrieves the signal data at a timing not involving the backoff from the memory 130 (step S926), and performs the reception processing (step S927).

As described above, in the second embodiment of the present technology, when it is notified with the hint information 712 that the backoff has occurred in the past transmission data, the reception processing is performed on the signal data at the timing involving the backoff. This makes it possible to improve the communication performance while suppressing the occupied communication band and the amount of computation in the receiving device 100.

### 3. Third Embodiment

In this third embodiment, assumed is a communication system in which the transmitting device 200 includes in transmission data a value indicating an amount of deviation in time domain of the transmission timing of the data transmitted in the past. In the case where the transmitting device 200 is time-synchronized with the Global Positioning System (GPS), the transmitting device 200 may detect the deviation in the clock of the transmitting device 200 after transmitting data at a certain transmission timing, such as when the GPS reception environment changes from bad to good conditions. In this case, the transmitting device 200 may include in part of the transmission data the amount of deviation in time domain of the past transmission timing as the hint information 712.

The receiving device 100 holds the received signal data in the memory 130 for a certain period of time, and when notified with the hint information 712 about the amount of deviation in time domain for the reception processing performed at the timing at which the receiving device 100 failed to receive, retrieves the held signal data in consideration of the amount of deviation in time domain and then retries the reception processing. As a result, the receiving device 100 can improve the communication performance without speculatively performing reception processing in consideration of a deviation in time domain and without increasing the amount of computation.

Since the configuration of the receiving device 100 under such an assumption is the same as that of the first embodiment described above, detailed description thereof will be omitted.

### Operation

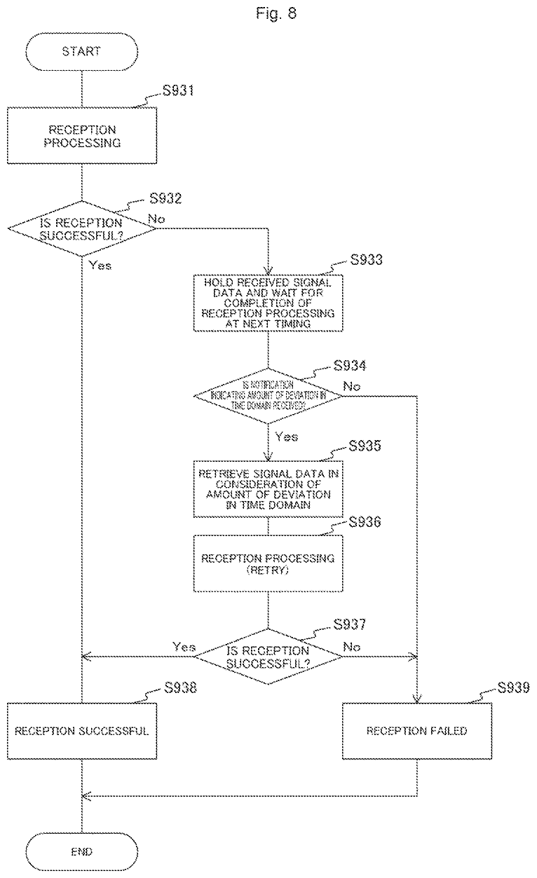

FIG. 8 is a flowchart illustrating an example of processing procedure of the receiving device 100 according to the third embodiment of the present technology.

At the timing t, the reception processing circuit 140 performs the reception processing (step S931). As a result, when the reception processing is successful (step S932: Yes), the reception processing at the timing t is successful accordingly (step S938).

On the other hand, when the reception processing is failed (step S932: No), the received data is held in the memory 130, and the completion of the reception processing at the next timing t+1 is awaited (step S933).

When the reception processing at the next timing t+1 is successful and if it is notified with the hint information 712 indicating “the amount of deviation in time domain of the timing t” (step S934: Yes), the reception processing circuit 140 retrieves the held signal data from the memory 130 in consideration of the amount of deviation in time domain (step S935), and retries the reception processing (step S936). As a result, when the reception processing is successful (step S937: Yes), the reception processing at the timing t is successful accordingly (step S938).

On the other hand, if the hint information 712 does not indicate “the amount of deviation in time domain of the timing t” (step S934: No), or when the retry of the reception processing is failed (step S937: No), the reception processing at the timing t is failed accordingly (step S939).

As described above, in the second embodiment of the present technology, when it is notified with the hint information 712 about the amount of deviation in time domain of the previous timing, the previous reception processing is retried. This makes it possible to improve the communication performance while suppressing the occupied communication band and the amount of computation in the receiving device 100.

### Modification Example

In a case where the transmitting device 200 performs frequency correction using a GPS clock on, for example, the RF frequency, a value indicating an amount of deviation in frequency domain may be included in the transmission data as the hint information 712.

### 4. Fourth Embodiment

In this fourth embodiment, assumed is a communication system in which the transmitting device 200 performs carrier sensing before transmitting data, and when detecting that another device is communicating, the transmitting device 200 does not perform transmission. The receiving device 100 holds the received signal data in the memory 130 for a certain period of time, and the transmitting device 200 includes, in transmission data, a sequence number that is incremented by one each time the data is transmitted, as the hint information 712.

The receiving device 100 checks whether or not the sequence numbers included in two pieces of transmission data that have been successfully received have changed by 2 or more, so that whether there is transmission data that has been failed to be received between the two pieces of transmission data can be detected. If there is such data, signal data at a transmission timing between the two pieces of transmission data is retrieved from the signal data held in the memory 130, and the reception processing is performed with, for example, an increased number of iterations of error correction processing, which is more than normal. As a result, the receiving device 100 performs reception processing with a large amount of computation only on signal data at a timing at which the transmitting device 200 is highly likely to have transmitted the data, so that it is possible to improve the communication performance while suppressing an increase in the overall amount of computation.

Since the configuration of the receiving device 100 under such an assumption is the same as that of the first embodiment described above, detailed description thereof will be omitted.

### Operation

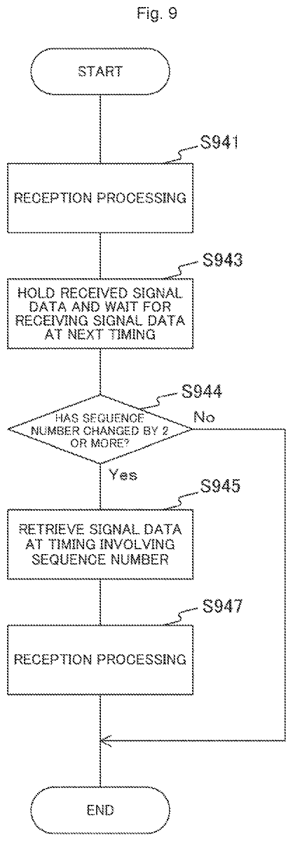

FIG. 9 is a flowchart illustrating an example of processing procedure of the receiving device 100 according to the fourth embodiment of the present technology. The receiving device 100 receives signal data (step S941), holds it in the memory 130 for a certain period of time, and waits for reception of signal data at the next timing (step S943).

If it is found that the sequence number has changed by 2 or more from the past transmission data in the hint information 712 of the signal data at the subsequent timing from the transmitting device 200 (step S944: Yes), the reception processing circuit 140 retrieves signal data at a transmission timing between the two pieces of transmission data from the memory 130 in response to an instruction from the control circuit 160 (step S945), and performs the reception processing (step S947). On the other hand, if the sequence number has not changed by 2 or more (step S944: No), the processing proceeds with no transmission data that has been failed to be received.

As described above, in the fourth embodiment of the present technology, when it is found that the sequence number has changed by two or more from the hint information 712, the reception processing is performed on the transmission data that has been failed to be received. This makes it possible to improve the communication performance while suppressing the occupied communication band and the amount of computation in the receiving device 100.

### 5. Fifth Embodiment

The hint information 712 is included in the transmission data in each of the above-described embodiments. On the other hand, in this fifth embodiment, the transmission data further includes a flag indicating whether the hint information 712 is enabled or disabled.

Since the configuration of the receiving device 100 under such an assumption is the same as that of the first embodiment described above, detailed description thereof will be omitted.

### Signal Data Format

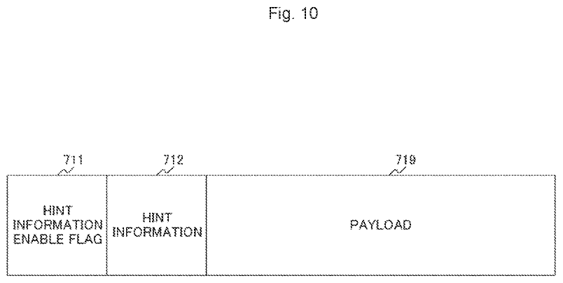

FIG. 10 is a diagram illustrating a format structure example of signal data according to the fifth embodiment of the present technology.

Here, in signal data, a field of hint information 712 is provided for payload 719, and a field of hint information enable flag 711 indicating whether the hint information 712 is enabled or not is provided.

In each of the above-described embodiments, when the transmitting device 200 includes the hint information 712 in transmission data, for example, there may be no data transmitted in the past for the initial transmission, or the hint information 712 may fail to be generated for some reason. In such a case, the hint information enable flag 711 indicating whether the hint information 712 is enabled or disabled is included in the transmission data, so that the transmitting device 200 can notify the receiving device 100 whether the hint information 712 is enabled or not. The receiving device 100 determines whether or not to refer to the hint information 712 by referring to the hint information enable flag 711.

Thus, in the fifth embodiment of the present technology, the signal data includes the field of hint information enable flag 711 indicating whether the hint information 712 is enabled or not. This allows the receiving device 100 to correctly determine whether or not to refer to the hint information 712.

### 6. Sixth Embodiment

In this sixth embodiment, assumed is a communication system in which the transmitting device 200 notifies the moving speed of the transmitting device 200 as the hint information 712. In this case, the receiving device 100 can perform the reception processing after performing correction in consideration of the Doppler effect using the following equation.

$${v}^{′} = v \times \frac{\sqrt{1 - {( V / c )}^{2}}}{1 - ( V / c ) cos θ} \qquad [ Math . 1 ]$$

Here, v is the output frequency of the transmitting device 200, V is the moving speed of the transmitting device 200, c is the speed of light, θ is the angle of the moving direction of the transmitting device 200 as seen from the receiving device 100, and v′ is the frequency observed by the receiving device 100.

The receiving device 100 calculates, for data transmitted in the past, an amount of correction of frequency (v—v′) from the moving speed of the transmitting device 200 at that time, sets it as a preset value of the frequency correction amount, and executes the reception processing again, so that the probability of success of the reception processing can be increased.

### Operation

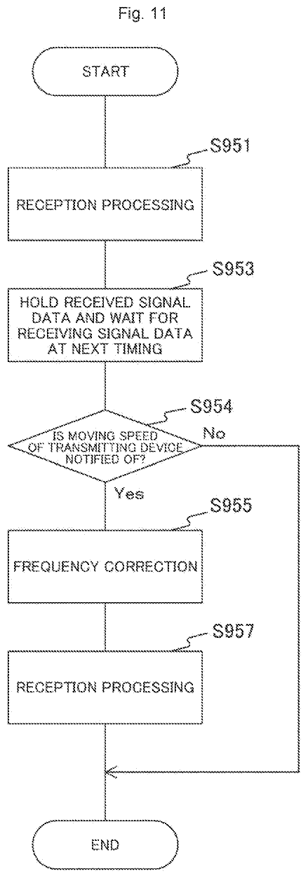

FIG. 11 is a flowchart illustrating an example of processing procedure of the receiving device 100 according to the sixth embodiment of the present technology. The receiving device 100 receives signal data (step S951), holds it in the memory 130 for a certain period of time, and waits for reception of signal data at the next timing (step S953).

In response to a notification with the hint information 712 of the signal data from the transmitting device 200 at the subsequent timing for the past transmission data about the moving speed V of the transmitting device 200 at that time (step S954: Yes), an amount of correction of frequency (v-v′) is calculated from the above equation (v-v′) (step S955). Then, the calculated frequency correction amount is set as a preset value, and the reception processing is executed again (step S957). As described above, according to the sixth embodiment of the present technology, the moving speed of the transmitting device 200 is notified as the hint information 712, the frequency correction is performed, and the reception processing is then executed again in the receiving device 100, so that the probability of success of the reception processing can be increased.

### 7. Seventh Embodiment

In this seventh embodiment, the transmitting device 200 notifies part of the payload transmitted by the transmitting device 200 in the past as the hint information 712. As a result, the receiving device 100 can execute the reception processing again with increased known data used for correlation calculation and thus with increased detection performance.

For example, in many communication systems, a pilot pattern is detected by obtaining a peak position of correlation values between known pattern information and actually received signals. In such communication systems, the more the known pattern information, the better the detection performance. Therefore, the receiving device 100 is notified with part of the payload of past transmission data in the hint information 712 to increase the number of known patterns used for correlation calculation, so that the receiving device 100 can execute the reception processing again with increased detection performance.

Further, for example, in an error correction algorithm for error correction coding such as LDPC, a log-likelihood ratio of received strength or the like is used as a value indicating the reliability of each bit. In that case, by replacing the value indicating the reliability for known data with a sufficiently large value, the error correction performance for unknown data can be increased. Therefore, the receiving device 100 is notified with part of the payload of past transmission data in the hint information 712 to increase known data, and the value indicating the reliability is replaced with a larger value, so that the reception processing can be executed again with increased detection performance for unknown data.

Since the configuration of the receiving device 100 under such an assumption is the same as that of the first embodiment described above, detailed description thereof will be omitted.

### Operation

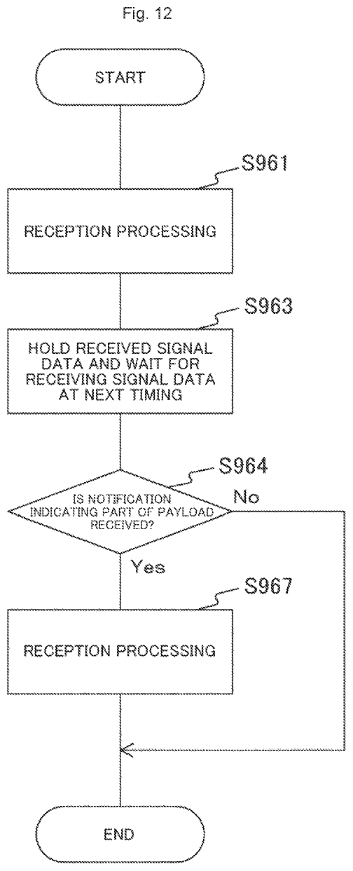

FIG. 12 is a flowchart illustrating an example of processing procedure of the receiving device 100 according to the seventh embodiment of the present technology. The receiving device 100 receives signal data (step S961), holds it in the memory 130 for a certain period of time, and waits for reception of signal data at the next timing (step S963).

In response to a notification with the hint information 712 of the signal data from the transmitting device 200 at the subsequent timing about part of the payload of the past transmission data (step S964: Yes), the reception processing is executed again using the part of the payload (step S967). For example, the number of known patterns used for correlation calculation is increased, or the value indicating the reliability is replaced with a larger value, to execute the reception processing again.

As described above, according to the seventh embodiment of the present technology, the receiving device 100 is notified with part of the payload of past transmission data in the hint information 712, so that the reception processing can be executed again with increased performance of pilot pattern detection and error correction processing.

### 8. Eighth Embodiment

In this eighth embodiment, assumed is a communication system in which a plurality of receiving devices are connected to a cloud and the plurality of receiving devices share the hint information 712.

### Configuration of Communication System

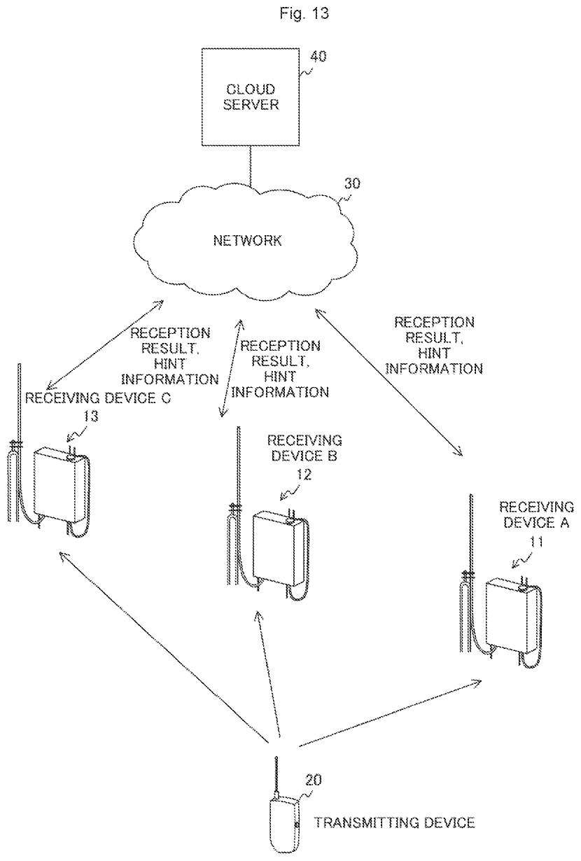

FIG. 13 is a diagram illustrating an example of an overall configuration of a communication system according to the eighth embodiment of the present technology.

A transmitting device 20 is a communication device that transmits signals, and receiving devices A, B and C (11 to 13) are communication devices that receive signals. Although three receiving devices 11 to 13 are illustrated here, four or more receiving devices may be used.

When the transmitting device 20 moves, there may be a case where even when the transmitting device 20 is located in the coverage area of the receiving device A 11 at a certain transmission timing, the transmitting device 20 is in the coverage area of another receiving device B 12 at the next transmission timing.

The transmitting device 20 includes, in transmission data, the hint information 712 for receiving data transmitted in the past. The receiving devices 11 to 13 hold the received signal data in the memory 130 for a certain period of time.

The receiving devices 11 to 13 are connected to a cloud server 40 via a network 30. The cloud server 40 receives results of receiving communication with the transmitting device 20 and the hint information 712 from the receiving devices 11 to 13

### First Example

In this first example of the eighth embodiment, the receiving devices 11 to 13 share the hint information 712 included in the successfully received data via the cloud server 40, so that the receiving device that is responsible for the coverage area where the transmitting device 20 was located at the transmission timing indicated by the hint information 712 can perform additional reception processing.

Each of the receiving devices 11 to 13 notifies the cloud server 40 of a flag indicating whether the reception processing at each timing is successful or not and the hint information 712 obtained when the reception is successful. In response to a notification, from any one of the receiving devices, with the hint information 712 about the timing at which all the receiving devices 11 to 13 fail to receive, the cloud server 40 notifies each of the receiving devices 11 to 13 of the hint information 712 to instruct each receiving device to perform additional reception processing. In response to the notification, from the cloud server 40, including the hint information 712 and the instruction for additional reception processing, the receiving devices 11 to 13 each retrieve the signal data at the corresponding timing from the memory 130 and perform the additional reception processing.

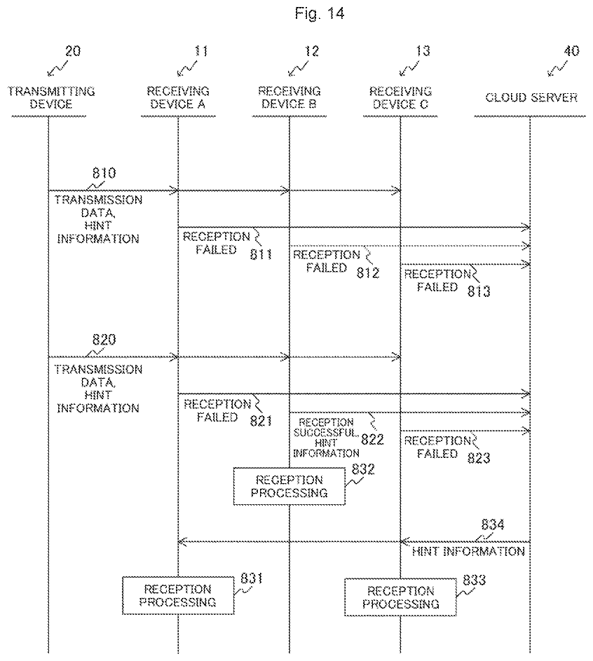

FIG. 14 is a sequence diagram illustrating an example of a flow of processing according to the first example of the eighth embodiment of the present technology.

First, the transmitting device 20 transmits transmission data and the hint information 712 to the receiving devices 11 to 13 (810). Here, it is assumed that all the receiving devices 11 to 13 have failed to receive from the transmitting device 20. In this case, each of the receiving devices 11 to 13 notifies the cloud server 40 of failed reception while holding the signal data in the memory 130 (811 to 813).

The transmitting device 20 transmits the next transmission data and the hint information 712 to the receiving devices 11 to 13 (820). Here, it is assumed that only the receiving device B 12 has successfully received from the transmitting device 20. In this case, the receiving devices A 11 and C 13 notify the cloud server 40 of failed reception while holding the signal data in the memory 130 (821, 823). Further, the receiving device B 12 notifies the cloud server 40 of successful reception and the hint information 712 (822), and performs the reception processing (832).

The cloud server 40 transmits the hint information 712 to the receiving devices A 11 and C 13 (834). The receiving devices A 11 and C 13 use the hint information received from the cloud server 40 to perform additional reception processing on the past signal data (831, 833).

### Second Example

In the above-described first example, it is assumed that each receiving device performs the reception processing individually. On the other hand, in this second example, it is assumed that the cloud server 40 collectively performs the reception processing. Specifically, when the cloud server 40 obtains the hint information 712 as to the timing at which all the receiving devices A 11 and C 13 failed to receive, additional reception processing is performed on the cloud server 40.

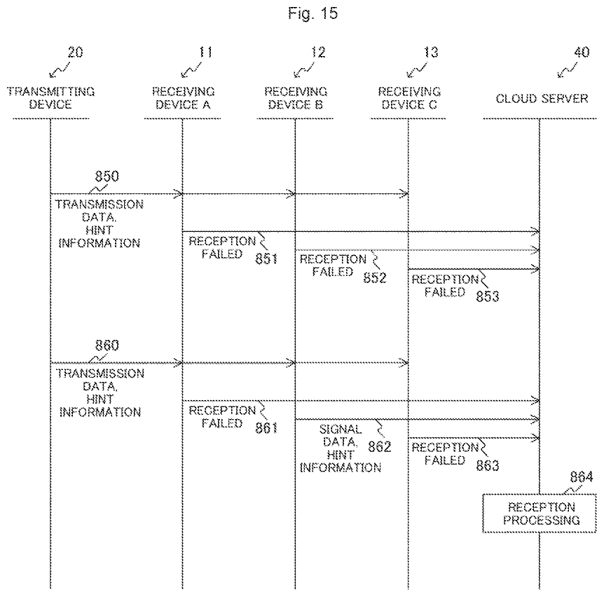

FIG. 15 is a sequence diagram illustrating an example of a flow of processing according to the second example of the eighth embodiment of the present technology.

First, the transmitting device 20 transmits transmission data and the hint information 712 to the receiving devices 11 to 13 (850). Here, it is assumed that all the receiving devices 11 to 13 have failed to receive from the transmitting device 20. In this case, each of the receiving devices 11 to 13 notifies the cloud server 40 of failed reception while holding the signal data in the memory 130 (851 to 853). This is the same as in the above-described first example.

The transmitting device 20 transmits the next transmission data and the hint information 712 to the receiving devices 11 to 13 (860). Here, it is assumed that only the receiving device B 12 has successfully received from the transmitting device 20. In this case, the receiving device B 12 notifies the cloud server 40 of the signal data and the hint information 712 (862). The receiving devices A 11 and C 13 notify the cloud server 40 of failed reception (861, 863).

The cloud server 40 performs additional reception processing using the hint information 712 from the receiving device B 12 (864).

As described above, in the second example of the eighth embodiment of the present technology, all the receiving devices 11 to 13 share the hint information 712 about the timing at which the receiving devices failed to receive. This makes it possible to allow the receiving devices 11 to 13 or the cloud server 40 to perform additional reception processing using the hint information 712.

The embodiments described above show examples for embodying the present technology and matters in the embodiments and matters specifying the invention in the claims have a correspondence to each other. Similarly, matters specifying the invention in the claims and matters in the embodiments of the present technology with the same names have a correspondence to each other. However, the present technology is not limited to the embodiments and can be embodied by making various modifications to the embodiments without departing from the spirit and scope of the present technology.

Further, the processing procedures described in the embodiments described above may be construed as a method having such a series of procedures or may be construed as a program for causing a computer to execute the series of procedures or a recording medium storing the program. Examples of such a recording medium to be used include a compact disc (CD), a MiniDisc (MD), a digital versatile disc (DVD), a memory card, and a Blu-ray disc (Blu-ray (registered trademark) Disc).

The effects described in the present specification are merely examples and are not intended as limiting, and other effects may be obtained.

The present technology can also have the following configurations.
(1) A receiving device including:
   a memory that holds past signal data;
   a hint information extraction circuit that extracts hint information from newly received signal data; and
   a reception processing circuit that reads the past signal data held in the memory based on the hint information to perform predetermined reception processing.
(2) The receiving device according to (1), wherein
   the reception processing circuit performs error correction processing as the predetermined reception processing,
   the memory holds data in the middle of the error correction processing as the past signal data, and
   the hint information extraction circuit extracts, as the hint information, information indicating whether transmission has been performed at a timing of the past signal data, and if the transmission has been performed at the timing of the past signal data, the hint information extraction circuit causes the reception processing circuit to continue the error correction processing.
(3) The receiving device according to (1), wherein the hint information extraction circuit extracts information on backoff of the past signal data as the hint information, and causes the reception processing circuit to perform the predetermined reception processing on signal data at a timing according to the information on the backoff.
(4) The receiving device according to (1), wherein the hint information extraction circuit extracts information on an amount of deviation in time domain of the past signal data as the hint information, and causes the reception processing circuit to perform the predetermined reception processing on signal data at a timing according to the information on the amount of deviation in time domain.
(5) The receiving device according to (1), wherein the hint information extraction circuit extracts information on a sequence number of the past signal data as the hint information, and causes the reception processing circuit to perform the predetermined reception processing on signal data of a timing according to the information on the sequence number.
(6) The receiving device according to (1), wherein the hint information extraction circuit extracts, as the hint information, information on a moving speed of a transmitting device that has transmitted the past signal data, and causes the reception processing circuit to perform the predetermined reception processing according to the information on the moving speed.
(7) The receiving device according to (1), wherein the hint information extraction circuit extracts, as the hint information, information on part of a payload of the past signal data, and causes the reception processing circuit to perform the predetermined reception processing using the information on the part of the payload as known data.
(8) The receiving device according to any one of (1) to (7), wherein the hint information extraction circuit further extracts information indicating whether the hint information is enabled or not, and if the information indicating whether the hint information is enabled or not indicates that the hint information is enabled, extracts the hint information.
(9) A communication system including:
   a transmitting device;
   a plurality of receiving devices each including a memory that holds past signal data having been transmitted from the transmitting device, a hint information extraction circuit that extracts hint information from newly received signal data, and a reception processing circuit that reads the past signal data held in the memory based on the hint information to perform predetermined reception processing; and
   a server that acquires the hint information from any one of the plurality of receiving devices and supplies the hint information to another one of the plurality of the receiving devices.
(10) A communication system including:
   a transmitting device;
   a plurality of receiving devices each including a hint information extraction circuit that extracts hint information from newly received signal data; and
   a server including a memory that holds past signal data having been received from the receiving device, and a reception processing circuit that acquires the hint information from any one of the plurality of receiving devices and reads the past signal data held in the memory based on the hint information to perform predetermined reception processing.

### REFERENCE SIGNS LIST

11 to 13 Receiving device
20 Transmitting device
30 Network
40 Cloud server
100 Receiving device
109 Antenna
110 RF (Radio Frequency) circuit
120 ADC (Analog-to-Digital Converter)
130 to 132 Memory
140 Receiving processing circuit
141 Preamble detection unit
142 Frequency correction unit
143 Filter
144 Decimation processing unit
150 Hint information extraction circuit
160 Control circuit
200 Transmitting device
209 Antenna
711 Hint information enable flag
712 Hint information
719 Payload

1. A receiving device comprising:
a memory that holds past signal data;
a hint information extraction circuit that extracts hint information from newly received signal data; and
a reception processing circuit that reads the past signal data held in the memory based on the hint information to perform predetermined reception processing.

2. The receiving device according to claim 1, wherein
the reception processing circuit performs error correction processing as the predetermined reception processing,
the memory holds data in the middle of the error correction processing as the past signal data, and
the hint information extraction circuit extracts, as the hint information, information indicating whether transmission has been performed at a timing of the past signal data, and if the transmission has been performed at the timing of the past signal data, the hint information extraction circuit causes the reception processing circuit to continue the error correction processing.

3. The receiving device according to claim 1, wherein the hint information extraction circuit extracts information on backoff of the past signal data as the hint information, and causes the reception processing circuit to perform the predetermined reception processing on signal data at a timing according to the information on the backoff.

4. The receiving device according to claim 1, wherein the hint information extraction circuit extracts information on an amount of deviation in time domain of the past signal data as the hint information, and causes the reception processing circuit to perform the predetermined reception processing on signal data at a timing according to the information on the amount of deviation in time domain.

5. The receiving device according to claim 1, wherein the hint information extraction circuit extracts information on a sequence number of the past signal data as the hint information, and causes the reception processing circuit to perform the predetermined reception processing on signal data of a timing according to the information on the sequence number.

6. The receiving device according to claim 1, wherein the hint information extraction circuit extracts, as the hint information, information on a moving speed of a transmitting device that has transmitted the past signal data, and causes the reception processing circuit to perform the predetermined reception processing according to the information on the moving speed.

7. The receiving device according to claim 1, wherein the hint information extraction circuit extracts, as the hint information, information on part of a payload of the past signal data, and causes the reception processing circuit to perform the predetermined reception processing using the information on the part of the payload as known data.

8. The receiving device according to claim 1, wherein the hint information extraction circuit further extracts information indicating whether the hint information is enabled or not, and if the information indicating whether the hint information is enabled or not indicates that the hint information is enabled, extracts the hint information.

9. A communication system comprising:
a transmitting device;
a plurality of receiving devices each including a memory that holds past signal data having been transmitted from the transmitting device, a hint information extraction circuit that extracts hint information from newly received signal data, and a reception processing circuit that reads the past signal data held in the memory based on the hint information to perform predetermined reception processing; and
a server that acquires the hint information from any one of the plurality of receiving devices and supplies the hint information to another one of the plurality of the receiving devices.

10. A communication system comprising:
a transmitting device;
a plurality of receiving devices each including a hint information extraction circuit that extracts hint information from newly received signal data; and
a server including a memory that holds past signal data having been received from the receiving device, and a reception processing circuit that acquires the hint information from any one of the plurality of receiving devices and reads the past signal data held in the memory based on the hint information to perform predetermined reception processing.
